(19) United States
(12) Patent Application Publication
(10) Pub. No.: US 2009/0178312 A1
(43) Pub. Date: Jul. 16, 2009

(54) ADVERTISING TROLLEY ARRANGEMENT

(76) Inventor: James Edward Honiball, Highway Gardens (ZA)

Correspondence Address: DARBY & DARBY P.C., P.O. BOX 770, Church Street Station, New York, NY, 10008-0770, US

(21) Appl. No.: 12/190,540

(22) Filed: Aug. 12, 2008

(30) Foreign Application Priority Data
Jan. 16, 2008 (ZA) 2008/00467

(51) Int. Cl. G09F 7/08; B62B 5/00

(52) U.S. Cl. 40/308

(57) ABSTRACT

An advertising trolley arrangement is provided, comprising a trolley comprising at least one basket defined by at least a pair of side walls and an end wall, at least one of the side walls or end wall comprising at least one frame border for defining at least one frame holder. The arrangement further comprises an advertising board located within one of the at least one frame holders. In an example embodiment, the advertising board is sized and shaped so as to be substantially surrounded by the at least one frame border. In an example embodiment, the advertising board is removably fittable within the frame holder. In an example embodiment, the trolley is a wire trolley, with the frame border comprising a wire frame. In an example embodiment, fastening means may be provided for fastening the advertising board to the trolley.

### FIELD OF THE INVENTION

This invention relates to an advertising trolley arrangement.

### BACKGROUND OF THE INVENTION

The idea of advertising on trolleys is not new. However, most existing advertising arrangements for trolleys are relative complicated, requiring a number of components and/or modifications to accommodate a board carrying the relevant advertising.

### OBJECT OF THE INVENTION

It is an object of this invention to provide an advertising trolley arrangement that is simple and convenient to implement, and that can easily be retrofitted to existing trolleys.

### SUMMARY OF THE INVENTION

In accordance with this invention there is provided an advertising trolley arrangement comprising:
a trolley comprising at least one basket defined by at least a pair of side walls and an end wall, at least one of the side walls or end wall comprising at least one frame border for defining at least one frame holder; and
an advertising board located within one of the frame holders.

In an example embodiment, the advertising board is sized and shaped so as to be substantially surrounded by the at least one frame border.

In an example embodiment, the advertising board is removably fittable within the frame holder.

In an example embodiment, the trolley is a wire trolley, with the frame border comprising a wire frame.

In an example embodiment, fastening means may be provided for fastening the advertising board to the trolley.

In an example embodiment, one, two or three frame borders are provided in one of the side walls and/or the end wall.

### BRIEF DESCRIPTION OF THE ANNEXURE

Annexure A lists various materials from which the advertising board may be made.

### BRIEF DESCRIPTION OF THE DRAWINGS

FIG. 1 shows a perspective view of an advertising trolley arrangement, according to a first example embodiment;

FIG. 2 shows a side view of the advertising trolley arrangement shown in FIG. 1; and

FIG. 3 shows a side view of an advertising trolley arrangement, according to a second example embodiment.

### DESCRIPTION OF PREFERRED EMBODIMENTS

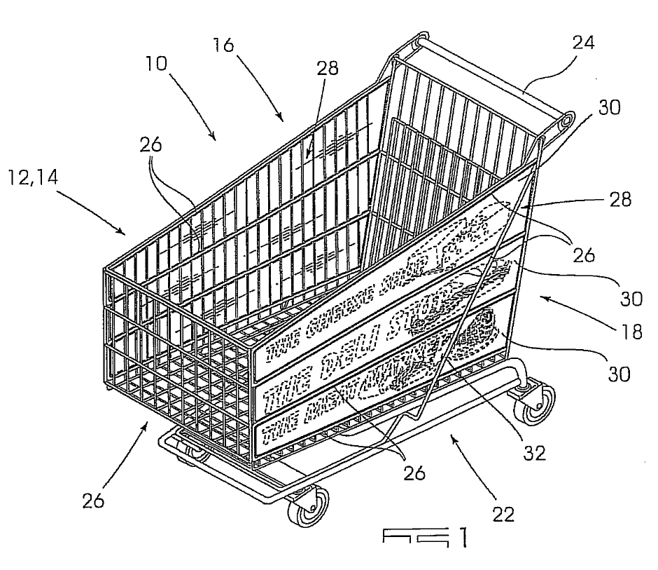

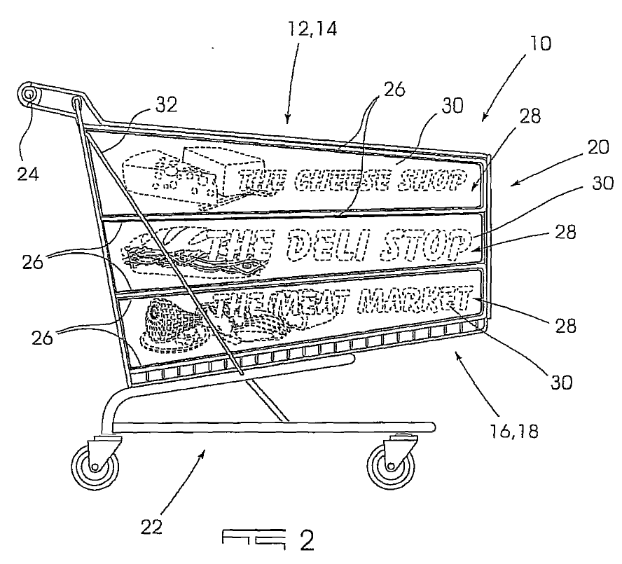

Referring first to FIGS. 1 and 2, an advertising trolley arrangement 10 comprises a trolley 12 comprising a basket 14 defined by at least a pair of side walls 16, 18 and an end wall 20.

In an example embodiment, the trolley 12 is a conventional wire trolley, with the basket 14 being fitted, at its bottom, to a wheeled carriage 22, and, at its top, with a handle 24 for allowing a user to push the trolley 12.

Significantly, at least one of the side walls 16, 18 or end wall 20 comprises at least one frame border 26 for defining at least one frame holder 28.

In an example embodiment, one, two or three frame borders are provided in one of the side walls and/or the end wall. In the illustrated embodiment, each of the side walls 16, 18 and end wall 20 comprises three frame borders.

Since the trolley 12 is typically a wire trolley, the frame border 26 will correspondingly also typically comprise a wire frame.

The advertising trolley arrangement 10 comprises an advertising board 30 located within one of the frame holders 28. In an example embodiment, as illustrated, the advertising board 30 is sized and shaped so as to be substantially surrounded by the frame border 26. In this embodiment, the advertising board 30 is thus snugly accommodated within the frame holder 28.

The advertising board 30 may be removably fittable within the frame holder 28.

In the illustrated embodiment, a supporting strut 32 for strengthening the overall trolley 12 may conveniently be used to secure the advertising board 30 in position. Alternatively, or in addition, fastening means (not shown) may be provided for fastening the advertising board 30 to the trolley 12. The fastening means may take the form of conventional clips, double sided tape or complementary Velcro™ strips.

The advertising board may be made from any of the materials listed in Annexure A.

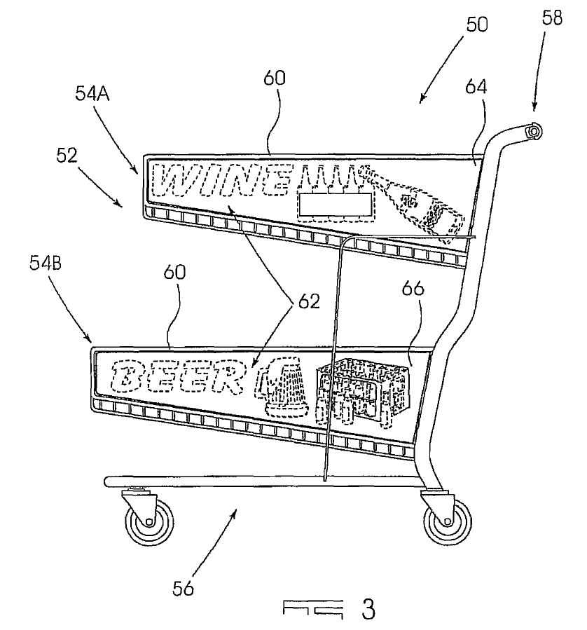

Turning now FIG. 3, an advertising trolley arrangement 50 comprises a trolley 52 comprising two baskets 54A, 54B, each defined by side walls and end walls. In this example embodiment, the trolley 52 is also a wire trolley, with lower baskets 54B being fitted, at its bottom, to a wheeled carriage 56, and upper basket 54A with a handle 58.

As with the first embodiment in FIGS. 1 and 2, at least one of the side walls and/or end walls comprises at least one frame border 60 for defining at least one frame holder 62. Thus, and as described above, the advertising trolley arrangement 50 comprises advertising boards 64, 66 that are sized and shaped so as to be snugly, but removably, located within the frame holders 62.

Again, fastening means may be provided for fastening the advertising boards 64, 66 to the trolley 52.

This invention thus provides an advertising trolley arrangement that is simple and convenient to implement, and that can easily be retrofitted to existing trolleys.

1. An advertising trolley arrangement comprising:
a trolley comprising at least one basket defined by at least a pair of side walls and an end wall, at least one of the side walls or end wall comprising at least one frame border for defining at least one frame holder; and an advertising board located within one of the frame holders.

2. The advertising trolley arrangement of claim 1, wherein the advertising board is sized and shaped so as to be substantially surrounded by the at least one frame border.

3. The advertising trolley arrangement of claim 1, wherein the advertising board is removably fillable within the frame holder.

4. The advertising trolley arrangement according to claim 1, wherein the trolley is a wire trolley, with the frame border comprising a wire frame.

5. The advertising trolley arrangement according to claim 1, wherein fastening means are provided for fastening the advertising board to the trolley.

6. The advertising trolley arrangement according to claim 1, wherein one, two or three frame borders are provided in one of the side walls and/or the end wall.
